(19) United States
(12) Patent Application Publication
(10) Pub. No.: US 2006/0011802 A1
(43) Pub. Date: Jan. 19, 2006

(54) Vertical casting apparatus and method

(75) Inventor: David Anthony Di Cesare, Invermay (AU)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: PROFAST

(21) Appl. No.: 10/969,982

(22) Filed: Oct. 22, 2004

(30) Foreign Application Priority Data
Apr. 24, 2002 (AU) PS1929
Apr. 23, 2003 (WO) PCT/AU03/00477

(51) Int. Cl. E04B 1/16; B28B 7/02

(52) U.S. Cl. 249/158; 264/33; 264/34

(57) ABSTRACT

A mould assembly for manufacturing prefabricated concrete panels including an upper level for pouring a concrete mixture therefrom, and a lower level adapted to form a substantially vertical mould cavity for receiving the concrete mixture, wherein the substantially vertical mould cavity is adjustable to form concrete panels of varying dimensions.

### FIELD OF THE INVENTION

The present invention relates to an apparatus for and a method of manufacturing concrete wall panels for use in building construction.

### BACKGROUND OF THE INVENTION

In the construction industry there has been an increasing trend in the use of prefabricated construction panels for building construction. This trend has been attributed to the fact that such panels are more versatile and economical to manufacture then traditional poured-in-place walls or brick and mortar variations. With continuing improvements in pre-cast concrete technology and cost efficiency requirements this trend is expected to increase and as such more efficient methods of manufacturing such panels are required to meet this increased demand.

Concrete construction panels have found particular application in exterior structures and surfaces, and such construction panels are frequently reinforced by rigid members which are either embedded into the concrete panel or attached to the concrete panel externally to provide further strength and rigidity.

Traditional methods of constructing building basements are well established and in commercial structures for high volume residential developments with identical dimensions for each building, poured concrete is used. This method involves the construction of forms, either wood or metal, in the exact shape of the vertical walls, and then pouring concrete into the forms. After the concrete hardens, the forms are removed and construction continues on the rest of the building. As can be appreciated this technique is both time consuming and labour intensive and is limited by the amount of manpower available at the construction site, which is also often limited by costs associated with the labour.

With the introduction of prefabricated panels over the years, it has been possible to introduce significant cost savings and reduce labour requirements in the construction industry. Prefabricated panels are frequently made up in a factory and shipped to a site for forming interior and exterior walls of a building. Typically the prefabricated panels are made on a flat bed or a tilt table where the panels are cast into an appropriate form with the appropriate reinforcing to suit the building task required. Following the setting of the panel, the panel is then lifted from the horizontal position into a vertical position, where it is then stored in preparation for transport to the construction site.

There are a number of problems associated with forming these panels in a horizontal plane and then handling them for transportation to the construction site. Firstly, due to the fact that the panels are typically large in area, the factory space required to mass produce these panels in the horizontal is considerably large. This is particularly an issue when the panel takes a considerable amount of time to cure following pouring of the concrete, and this results in the casting table/bed being occupied for a considerable period of time. Therefore in order to construct such panels in high volume, there is a considerable amount of labour intensive work required and unnecessary handling of the panels prior to transportation, as they must be removed from the table and transferred to a holding area prior to transportation.

Further to this, as such panels have considerable weight, the traditional handling methods are quite hazardous as the panels must be manipulated into a vertical position from the horizontal. As such much care and caution is required in handling such panels to ensure that the work environment is safe, whilst the output of panels being produced is optimised.

To this point, attempts at manufacturing prefabricated panels in a vertical position have proven to be unsatisfactory. Prior vertical manufacturing methods have tended to suffer from air bubbles being trapped in the wall face following pouring, resulting in a less than optimal product. Attempts to resolve this issue have seen the introduction of vibrating devices that vibrate the concrete in an attempt to eliminate bubbles, however such vibrators are extremely noisy resulting in much noise pollution and a work environment that is particularly unpleasant to work in.

U.S. Pat. No. 3,843,089 to Scholtz et al, describes one such prior art vertical moulding system. This patent describes a method and apparatus for manufacturing concrete slabs where the front and back surfaces of the wet concrete slabs can be impressed with a desired texture to achieve a patterned slab design. The mould disclosed essentially consists of a mobile vertical wall and framework and a stationary vertical wall and framework, which together define a vertical space into which concrete is poured. End gates are provided to form the side surfaces of the mould with a bottom stationary curb forming the lower horizontal surface of the mould. Such a mould requires a large number of parts to form the moulding space, and cannot easily be adapted to mould slabs of varying size and shape and multiple slabs in succession. Further, the mould extends vertically upwards from a horizontal factory floor thereby making it necessary to design the factory space to have a very high roof such that the pouring of the slabs can be facilitated and the finished slabs handled by a conventional crane equipment. Such a tall vertical mould is not readily accessible by workman and requires significant framework embedded in a concrete foundation of the factory floor to hold the stationary wall safely in position against the weight of the concrete being poured as well as the workman and equipment it supports. As such, the described apparatus is difficult and hazardous to operate requiring a factory with a high vertical space to accommodate the mould, and is not readily adaptable to mass produce slabs or even produce slabs of varying size and shape, as each slab must be removed before another slab can be poured.

With the increased demand for prefabricated panels in the construction industry there is a very real need to provide a method of manufacturing such panels in a manner that optimises the space required to mass produce panels of varying sizes, improves the safety associated with handling such panels and which eliminates the excessive handling of such panels following curing, for delivery to the construction site.

The present invention is therefore directed towards a method and apparatus for manufacturing prefabricated concrete panels that overcomes the above-mentioned problems with the prior art. In particular, the present invention provides an improved method and system for mass producing such panels which is safe to operate, easy to set-up and modify, and which optimally utilises factory space in pouring and storing the panels.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

### SUMMARY OF THE INVENTION

The present invention aims to overcome the shortcomings of the prior art by providing a method of manufacturing prefabricated concrete panels that optimises factory space, eliminates labour intensive work and excessive handling of the panels, improves factory safety, increases production and reduces noise pollution.

According to a first aspect, the present invention resides in a mould assembly for manufacturing prefabricated concrete panels comprising an upper level for pouring a concrete mixture therefrom, and a lower level adapted to form a substantially vertical mould cavity for receiving said concrete mixture, wherein said substantially vertical mould cavity is adjustable to form concrete panels of varying dimensions.

In a preferred embodiment the upper level is a factory floor level for pouring the concrete mixture which represents a typical manufacturing workspace that is accessible by workmen and machinery. In such an embodiment, the mould assembly is a split level arrangement with the lower level preferably being a sunken floor level defining a manufacturing workspace below said upper level. Such a sunken lower level is also accessible by workmen and machinery and represents a workspace for handling the moulded panels.

In one embodiment, the lower level comprises at least one fixed wall and one mobile wall, with the mobile wall being movable with respect to the fixed wall to form part of said substantially vertical mould cavity. More preferably, the lower level of the mould assembly comprises two fixed walls and one mobile wall defining a moulding space forming the framework of the substantially vertical mould cavity.

At least one insert member can be positioned in relation to the fixed wall and the mobile wall to establish the substantially vertical mould cavity. In a preferred embodiment an insert member forms the bottom wall and a side wall of the substantially vertical mould cavity, with a fixed wall forming the front wall and the other side wall of the cavity. In this regard the mobile wall is adapted to form the back wall of the cavity. Such an arrangement allows the dimensions of the panels made by the present invention to be easily adjusted. The height of the panels formed by the present invention can be adjusted by adjusting the position of the insert member forming the bottom wall of the substantially vertical mould cavity. Equally, the width of the panel can be adjusted by adjusting the position of the insert member forming the side wall of the substantially vertical mould cavity, and the thickness of the concrete panel can be adjusted by adjusting the position of the mobile wall forming the back wall of the substantially vertical mould cavity. Such an arrangement makes it possible for the present invention to be employed to create a wide variety of sized panels in accordance with the desired applications

In a further embodiment, the mould assembly of the present invention can be adapted to manufacture a plurality of panels in the one assembly. This is achieved by moving the mobile wall with respect to the previously poured concrete panel to form an additional vertical mould cavity behind the previously formed concrete panel inserts are again used to create the cavity against the previously cast concrete panel and a separator plate can be placed behind the previously poured panel to form a smooth surface of the mould cavity. In this regard, the assembly is capable of producing a large number of vertically moulded panels, thereby optimising factory space and enabling the panels to be handled en masse, thereby increasing manufacturing efficiency and reducing costs associated with labour and handling.

In another aspect, the present invention resides in a method of manufacturing prefabricated concrete panels comprising the steps of pouring a concrete mixture into a substantially vertical mould cavity having a mobile rear wall, allowing said concrete mixture to substantially set thereby forming a first prefabricated concrete panel, moving said mobile rear wall remote from said first prefabricated concrete panel thereby forming a further vertical mould cavity behind said first prefabricated concrete panel, and pouring a concrete mixture into said further vertical mould cavity to form a further prefabricated concrete panel behind said first concrete panel.

In a preferred embodiment of this aspect a factory can be set up with a plurality of mould assemblies arranged to enable a large volume of panels to be cast at the one time to increase output of the process.

According to a further aspect, the present invention resides in an apparatus for manufacturing prefabricated concrete walls in a vertical plane wherein there exists a vertical pouring bay, the said pouring bay having a front wall and at least one side wall and a mobile shutter arrangement positioned therein, said mobile shutter is movable in a direction substantially parallel with said front wall of said pouring bay and forms an adjustable pouring mould with said front wall of said pouring bay, said adjustable pouring mould resembling the shape of the vertical panel to be cast, wherein following pouring and casting of a first panel said mobile shutter is moved into a position remote from said front wall of said pouring bay to form a further pouring mould with said outer wall of said previous moulded panel. In a preferred embodiment, there exist a plurality of pouring bays arranged in an offset manner in a factory space for mass producing such prefabricated panels. In such an arrangement it is possible to pour a panel in each bay and following casting of the panel, to pour another panel directly behind the previous panel without removing the previously cast panel. This arrangement allows this process to be repeated until each bay is full of panels, wherein the complete panels can be removed and transported en masse to the construction site. With the present invention, panels can also be removed singularly as desired, and this can occur at a minimum curing time after pouring.

In another aspect the present invention resides in a method of manufacturing a prefabricated concrete panel in a vertical position wherein a concrete mix is poured into a vertical space having an adjustable wall, said space resembling the shape and dimensions of the panel to be cast; following casting of said panel said adjustable wall is moved into a position forming a further vertical space between the adjustable wall and said previously cast panel; wherein a concrete mix is poured into said newly formed space forming a further cast panel.

The panel formed by said method is in a complete form requiring no further screeding, trowelling or finishing. The only exposed surface of the panel requiring any labour is the exposed top surface where the concrete is poured into, and the only additional labour required is that associated with tidying the final amount of waste of concrete after pouring and using an edging tool along this surface to provide an appropriate finish. In such an instance said panel formed by said method can be directly removed from the pouring bay and transported to the construction site ready for use.

In a preferred embodiment said method is repeated until a bay of panels is available for subsequent delivery to a construction site.

### BRIEF DESCRIPTION OF THE DRAWINGS

By way of example only, a preferred mode of carrying out the invention is described with reference to the accompanying drawings, in which:

FIG. 1 shows a representation of a prior art arrangement for manufacturing a prefabricated panel in a horizontal plane.

FIG. 2 is a view of the manufacturing arrangement of the present invention showing in detail one pouring bay.

FIG. 3 shows the pouring bay of FIG. 1 in a position for pouring of a panel according to the present invention.

FIG. 4 shows the pouring bay of FIGS. 2 and 3 following the pouring and casting of a plurality of prefabricated building panels according to the present invention.

FIG. 5 shows in more detail a pouring bay according to the present invention.

FIG. 6 shows an arrangement for pouring varying sized panels according to the present invention.

### PREFERRED MODE OF CARRYING OUT THE INVENTION

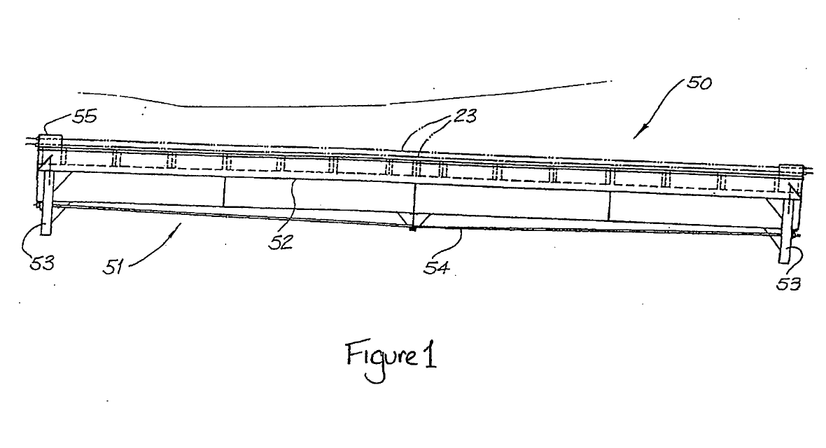

To gain an understanding of the present invention, reference is first made to a typical and commercially used prior art arrangement as shown in FIG. 1. This figure shows a schematic side elevation of a casting bed 50 showing a plurality of longitudinally extending tendons 23, bed support assemblies 55 and support legs 53. The casting bed includes a base frame 51 consisting of a generally planar and horizontal base 52 with an upward facing surface on which panels are cast, supported on legs 53. Such an arrangement allows the panels to be cast in a horizontal plane and when casting is complete the panels require lifting into a vertical position for subsequent transport via a crane or the like onto a transportation device such as a truck or other such large vehicle. In the prior art arrangement as shown in FIG. 1, a large amount of factory space is required to produce panels in large quantities as the amount of factory space required is largely dictated by the planar surface area of the panels to be cast. In order to overcome this problem, stackable casting beds have been proposed wherein each of the beds can be placed atop another to form a layered casting system. Whilst this method improves the factory space utilisation, it further complicates the handling of the cast panels, as the removal of each of the panels from each casting bed requires significant manpower and care to load such panels for delivery. As well as the obvious safety issues associated with transferring a concrete slab of significant weight from a horizontal to a vertical position, the considerable stresses associated with performing such an action can cause damage to areas of the panel and in some instances can cause fracture and cracking in the panel, destroying the integrity of the panel and deeming it useful for its purpose and creating unnecessary wastage in time and materials. It has also been found that estimating the time after pouring to perform this lifting task is both risky and dangerous, as often this time has been miscalculated resulting in poorly cured panels breaking under the stresses associated with the lifting action.

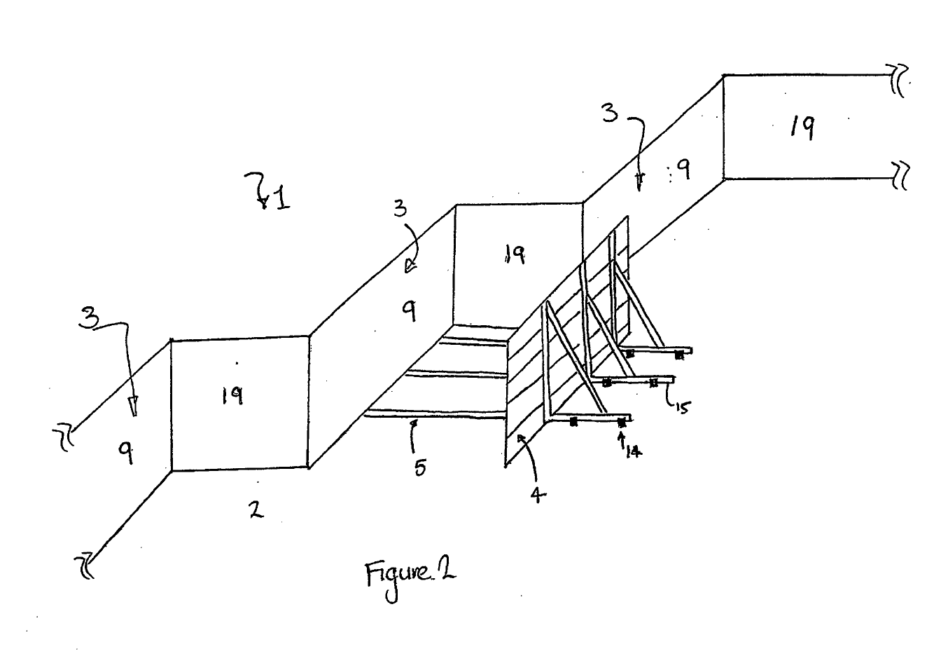

Therefore according to FIG. 2-4, the system and method of the present invention is shown which satisfies this need to mass produce prefabricated building panels in an efficient and safe manner. In essence these figures show a factory arrangement for manufacturing vertically cast prefabricated panels according to a preferred embodiment of the present invention.

As can be seen, the present invention requires a split-level floor space wherein each of the pouring bays 3 are arranged below a floor level 1 where the pouring of the concrete is performed. In the depicted embodiment, each of the bays 3 is arranged in a zig-zag arrangement wherein one of the bays is off-set laterally from the preceding bay, having a series of walls extending from upper floor level 1 to lower floor level 2. The zig-zag arrangement allows concrete delivery vehicles to attend to each bay separately from the upper floor level 1 with greater access and reduced driver expertise, however the present invention could be applied to non zig-zag arrangements equally whilst still falling within the scope of this invention.

The depth of the bays 3 is variable, depending on the required dimensions of the panels to be made however in a preferred embodiment the depth of the bays is about 3.4 metres with a width of about 8.0 metres. These dimensions allow for a panel that can be comfortably handled and transported, however larger bays could also be incorporated should the need exist. Generally, the size of the bays should be chosen to accommodate the largest required panel, as the present invention can be easily adapted to manufacture panels of smaller sizes.

Arranged in each of the bays 3 is a movable steel shutter 4, which is movable on a plurality of rail tracks 5 away from the vertical wall 9 of the bay 3. The purpose of this movable shutter 4 is to form a pouring mould between the surface of the movable shutter 4 and the vertical wall 9 of the bay 3, into which concrete can be poured from the upper level 1 into the mould for casting the prefabricated panel as required. As would be appreciated by a person skilled in the art, reinforcement and panel components can also be positioned within this mould as desired.

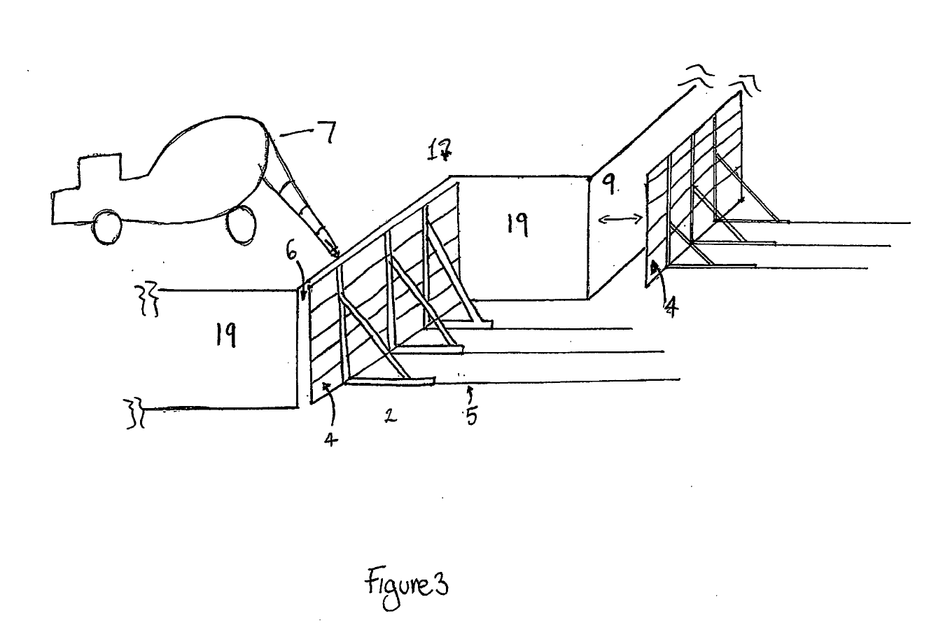

As shown in FIG. 3, the movable shutter 4 can be positioned and locked in place, so that the shutter forms a mould space 6 having a thickness of the desired width of the panel to be formed, for example, 150 mm. The shutter can be locked in place via a number of methods which prevent the shutter from moving under the weight of the concrete being poured into the mould space 6. One such means can be through the use of metal pegs that extend through the rail supports 15 and are received in recesses or holes in the lower floor level 2, however ratchet or motor means could also be employed to achieve this locking action. In a most simple embodiment the mould space 6 is defined by the permanent wall of the pouring bay 19, the movable shutter 4, and the face 9 of the pouring bay 3. Therefore the non-defined surfaces of the mould space 6 is the top surface which is initially left open to allow concrete to be poured and finished into the mould space 6, the bottom surface which is put in place by an operator of the present invention to define the height of the panel to be cast, and an open side wall opposite the pouring bay wall 19, which is also put in place by an operator of the present invention to define the width of the panel to be cast, as will be discussed in more detail below.

Concrete is poured from a source such as a mixer/hopper 7, and at this stage a concrete additive can be added to the poured concrete to assist in the reinforcing of the concrete and the compacting of the concrete. In order to reduce the formation of bubbles in the concrete which has previously been a limiting factor associated with casting panels in a vertical orientation, a self compacting concrete is used. This product eliminates the need for vibrators and the like and ensures that the concrete compacts as necessary. The action of pouring the concrete into the mould can be done in a number of ways, such as via the use of an appropriate pump means or under the force of gravity. One method of pouring the concrete into the mould may be via the use of a “tremmie pipe” which extends into the mould space 6, preferably to the bottom of the mould space. Such a method allows the concrete to be poured from the upper level 1 into the bottom of the mould space 6, thereby filling the mould from the bottom up, rather then merely pouring concrete directly into the mould and filling the mould in a typical manner. Such a system will improve the settling of the concrete within the mould and reduce the formation of bubbles within the panel.

Following the pouring and casting of the concrete panel, the movable shutter can then be unlocked and moved back a distance from the previously cast panel, in readiness for the pouring and casting of another panel behind the previously cast panel. A separator (not shown), such as a steel plate, can be placed between the outer wall of the previously cast panel and the inner face of the movable shutter 4 so that the concrete can be poured and separated from the previously cast panel. In this manner, panels can be cast and left in place until the bay is full and each of the panels have set/cured, where they are then ready for delivery to the appropriate construction site.

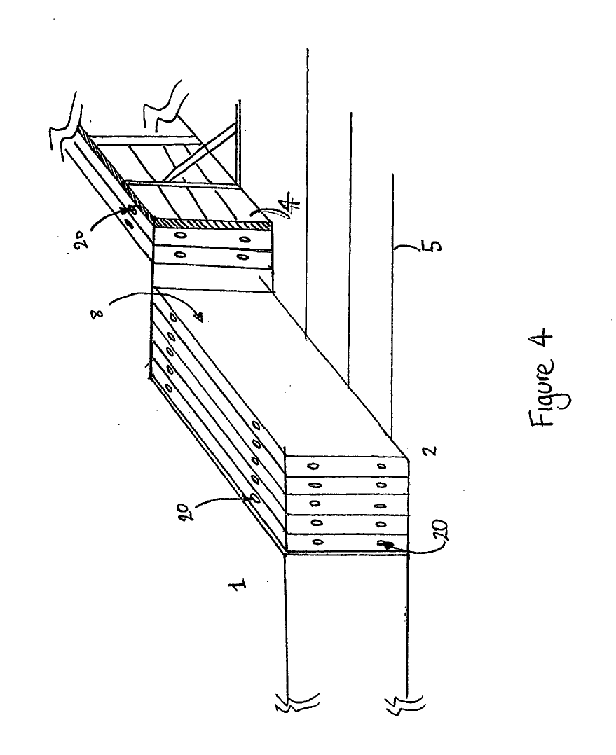

FIG. 4 shows such a condition wherein one of the bays is full with five cast panels 8 and ready for handling and delivery of the cast panels 8 to the construction site. As opposed to previous arrangements for the production of such panels such as that disclosed in FIG. 1, in the present invention, the handling of the panels from the casting site to the construction site is simple and safe. As the panel or panel(s) 8 are cast in a vertical position, they can easily be moved from the casting bay to the transport facility for delivery to the construction site. As shown, the panels can be cast with handling lugs/recesses 20 positioned therein so that a simple hoist or crane device can lift the panel(s) directly onto a transport vehicle or the like without the need for excessive handling of the panels 8, which are heavy and difficult to safely manoeuvre. In this regard, a hoist or crane can be placed on either the upper 1 or lower 2 floor level and the transport vehicle can equally access the bays from either level. With such an arrangement, there is no need to handle the panels 8 prior to removal, resulting in a much safer and space efficient factory environment.

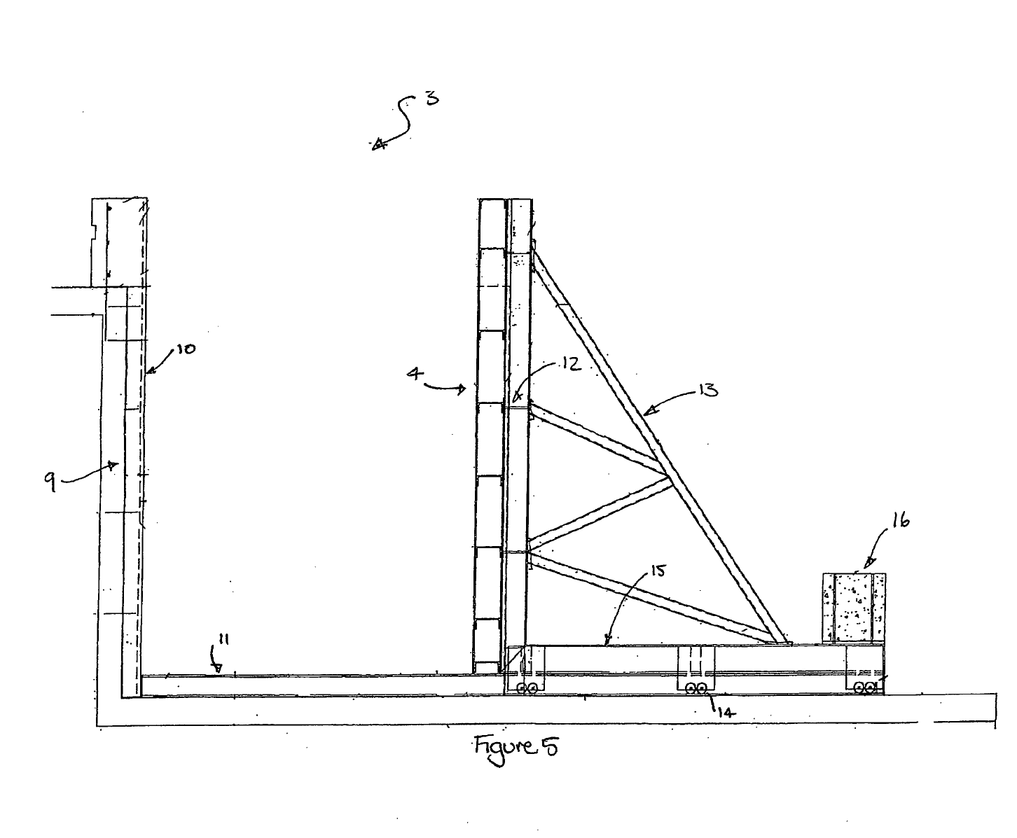

FIG. 5 shows in greater detail a pouring bay 3 of the present invention in accordance with one preferred embodiment. As can be seen, the bay consists of a fixed, vertical concrete wall 9 of approximately 150 mm thickness with a steel facing 10 positioned on the face of the wall and secured thereto by a series of fixing bolts (not shown). A plate 11 is also secured to the existing concrete floor forming a right angle with the fixed wall 9 of the pouring bay 3. A movable steel shutter 4 is then positioned parallel to the fixed wall 9 of the pouring bay, with the bottom surface of said movable shutter being flush with the tracks on the floor of the pouring bay. In a preferred embodiment the movable shutter has a smooth face facing the opposed smooth face of the fixed wall of the pouring bay. The movable shutter also has a series of stiffener plates 12 and truss members 13 arranged on the rear face of the shutter to support and maintain the shutter in a vertical position and to allow the pouring of concrete without any restriction or deflection to the shutter to provide a tolerance free panel.

The shutter is movable along the floor of the pouring bay via a plurality of wheels 14 movable along sunken tracks/rails 5 in the floor of the pouring bay 3. The tracks/rails can be placed on or incorporated in the floor of the bay 3 to allow the bottom of the shutter to finish flush with the tracks. A series of wheels 14 are positioned along a plurality of stabilising rail supports 15 which extend from the lower back face of the shutter in a perpendicular direction to the shutter, with each said rail support 15 aligning with each of the said tracks/rails 5 in/on the floor of the pouring bay. In this regard the shutter can be movable along the tracks/rails to allow the position of the shutter to be varied as desired to form a mould with either the fixed wall of the pouring bay, or a back wall of a previously cast panel member. The shutter can be moved after a minimum curing time and once the concrete has hardened sufficiently, preparation for the next pour can occur. In a preferred embodiment, in order to ensure stability of the vertical shutter, a stabilising block 16 is positioned across the rail plates in a plane parallel with the shutter.

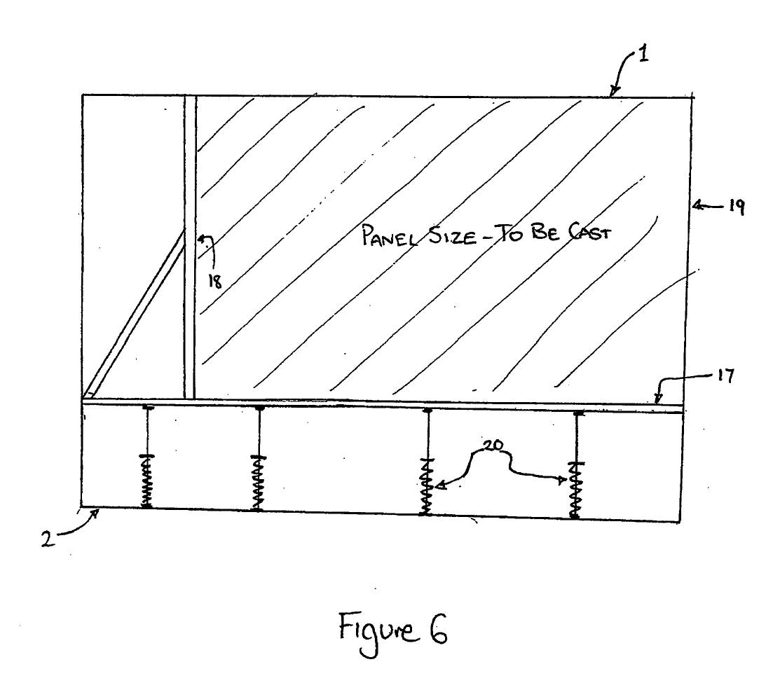

FIG. 6 shows in greater detail how a panel or panels, of varying size can be manufactured according to the present invention. In this diagram the shutter is omitted for clarity. As is shown, the sidewall 19 of the pouring bay extends from an upper floor level 1 to a lower floor level 2 and forms a permanent wall of the mould. The vertical height of the panel to be cast can be altered by providing a formwork floor 17 which is raised from lower floor level 2 of the pouring bay to provide a bottom surface of the mould. In this embodiment the formwork floor 17 is raised from the lower floor level via a series of screw jack arrangements 20 which allow the position of the formwork floor 17 to be adjusted to reduce the vertical height of the mould. A further formwork wall 18 is provided to enclose the exposed vertical side wall of the mould, namely the side wall of the mould opposite the side wall 19 of the bay. This formwork wall 18 extends from the upper floor level 1 to the formwork floor as required to define a breadth of the panel to be cast. By altering the position of this formwork wall, the breadth of the panel to be cast can be altered to suit the desired width of panel to be manufactured. This way the dimensions in terms of width and height of the mould defined by the present invention can be altered to allow panels of different size to be cast.

The formwork wall 18 and the formwork floor 17 are further secured in place by closing the movable shutter 4 against the face 9 of the pouring bay 3, thereby sandwiching the wall 18 and the floor 17 in place. In order to ensure that the formwork wall 18 and floor 17 provide a sealed wall and floor of the mould respectively, a foam seal can placed on either side of the framework prior to closing the shutter 4. Each of the formwork walls/floors 17, 18 may be made of a metal plate which is left in place until the panel is removed.

In the particular embodiment shown in FIG. 6, the mould is formed between the movable shutter wall 4 and the face 9 of the pouring bay. The floor 17, wall 18 and the permanent sidewall 19 of the pouring bay form the remaining walls of the mould with the mould being open at the top. It should be appreciated however that instead of using the face 9 of the pouring bay, the mould could be formed behind a previously cast panel, as described previously. In this regard, the mould would be formed between the movable shutter wall 4 and a separator plate.

In such a case, a series of similar sized or smaller sized panels may be cast behind the previously cast panel with the formwork walls and floors being adjusted to allow this.

The mould can be opened before the previously cast panel has fully cured or set, with a separator wall placed against the previously poured panel to form the next mould, which would allow multiple pours to occur in one day.

As can be appreciated, the present invention provides a mould for a concrete panel having three fixed sides, namely both faces of the mould, and one sidewall. The floor of the mould and the other sidewall are variable and positioned by the operator of the present invention. Such an arrangement allows the dimensions of the mould to vary to allow the manufacture of panels of varying heights, widths and thicknesses.

With the present invention as described, pouring of the concrete panels can take place at any hour as screeding, trowelling or finishing is not required, and following casting, the panels can be left in place until the bay is full.

The present invention provides considerable cost advantages over previously known manufacturing methods, as less materials are required, less factory space is required, less handling and manpower required, less curing methods are required and there is no longer a need to provide extensive factory storage space following casting. Together with improvements in cost efficiency, there is also an improvement in safety associated with handling of such products which has obvious advantages in an otherwise potentially hazardous working environment and ultimately provides an environmentally efficient facility.

Whilst the present invention represents a new process of manufacturing prefabricated building construction panels, it should be appreciated that standard components used in existing construction methods can also be used in the present invention. These include standard lifting techniques, bond breakers, and inserts which are commonly used in the art.

In an alternative embodiment of the present invention, the movable vertical shutter can be adapted to be move from the vertical position as shown in FIGS. 2-5 to a horizontal position as shown in FIG. 1. In this regard, the truss members 13 can be collapsible thereby allowing the present invention to be easily adaptable to act as a conventional flat casting bed arrangement positioned within each of the recessed bays 3.

Initial assessments of the present invention have shown that properly implemented, the present invention can provide a 100% improvement in production with a 75% decrease in labour. It has also been found that the present invention provides limited handling of finished panels and requires less lifting stress on panels, then is currently the case with known horizontally cast methods.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A mould assembly for manufacturing prefabricated concrete panels comprising an upper level for pouring a concrete mixture therefrom, and a lower level adapted to form a substantially vertical mould cavity for receiving said concrete mixture, wherein said substantially vertical mould cavity is adjustable to form concrete panels of varying dimensions.

2. The mould assembly of claim 1 wherein said upper level is a floor level defining a manufacturing workspace.

3. The mould assembly of claim 1 wherein the lower level is a floor level defining a manufacturing workspace below said upper level.

4. The mould assembly of claim 1 wherein the lower level comprises at least one fixed wall and one mobile wall, said mobile wall being movable with respect to said fixed wall to form part of said substantially vertical mould cavity.

5. The mould assembly of claim 4 wherein the lower level further comprises at least one insert member, said insert member being positioned in relation to said fixed wall and said mobile wall to define said substantially vertical mould cavity.

6. The mould assembly of claim 4 wherein the insert member forms at least a bottom wall of the substantially vertical mould cavity.

7. The mould assembly of claim 6 wherein the insert member forms a bottom wall and a side wall of the substantially vertical mould cavity.

8. The mould assembly of claim 4 wherein the fixed wall forms a front wall of said substantially vertical mould cavity.

9. The mould assembly of claim 8 wherein the fixed wall forms a front wall and a side wall of said substantially vertical mould cavity.

10. The mould assembly of claim 4 wherein the mobile wall forms a back wall of said substantially vertical mould cavity.

11. The mould assembly of claim 6 wherein the height of the concrete panel formed from the substantially vertical mould cavity can be adjusted by adjusting the position of the insert member forming the bottom wall of the substantially vertical mould cavity.

12. The mould assembly of claim 7 wherein the width of the concrete panel formed from the substantially vertical mould cavity can be adjusted by adjusting the position of the insert member forming the side wall of the substantially vertical mould cavity.

13. The mould assembly of claim 10 wherein the thickness of the concrete panel formed from the substantially vertical mould cavity can be adjusted by adjusting the position of the mobile wall forming the back wall of the substantially vertical mould cavity.

14. The mould assembly of claim 1 wherein following the formation of a concrete panel, the mobile wall can be moved with respect to the concrete panel to form part of a further substantially vertical mould cavity behind the previously formed concrete panel for manufacturing a plurality of concrete panels from the said mould assembly.

15. The mould assembly of claim 14 wherein said further substantially vertical mould cavity said insert member being positioned in relation to said fixed wall and said mobile wall to define said substantially vertical mould cavity.

16. A method of manufacturing prefabricated concrete panels comprising the steps of
pouring a concrete mixture into a substantially vertical mould cavity having a mobile rear wall;
allowing said concrete mixture to substantially set thereby forming a first prefabricated concrete panel;
moving said mobile rear wall remote from said first prefabricated concrete panel thereby forming a further vertical mould cavity behind said first prefabricated concrete panel; and
pouring a concrete mixture into said further vertical mould cavity to form a further prefabricated concrete panel behind said first concrete panel.

17. A method according to claim 16 wherein said steps are repeated to form a plurality of prefabricated concrete panels.
